(19) United States
(12) Patent Application Publication
(10) Pub. No.: US 2003/0111070 A1
(43) Pub. Date: Jun. 19, 2003

(54) Illuminating lamp system for unique barbecue

(76) Inventor: Robert A. DeMars, Woodland Hills, CA (US)

Correspondence Address: Donald Cislo, Cislo & Thomas LLP, Suite 900, 233 Wilshire Boulevard, Santa Monica, CA, 90401-1211, US

(21) Appl. No.: 10/017,340

(22) Filed: Dec. 13, 2001

(51) Int. Cl. F21V 33/00

(52) U.S. Cl. 126/25 R; 362/92

(57) ABSTRACT

A barbecue is illuminated by a light integrated into a shelf. The shelf may be hinged so that it folds into the barbecue for storage. A barbecue as is known in the art has an enclosing lid or cover. The shelves provide flat surfaces upon which food, plates, or other items may be supported. This provides additional work space to the chef. The shelves may be stationary or may fold into the barbecue. One of the shelves may have a lamp that articulates upwardly to illuminate the grill in times of insufficient light. The lamp also conforms to an exterior-interior circumference or perimeter of one of the shelves in order to provide convenient and unobtrusive means by which illumination can be provided when needed.

### BACKGROUND OF THE INVENTION

1. Field of the Invention

This invention relates to barbecues, outdoor cooking devices, and the like and more particularly to an illuminating light for an outdoor barbecue.

2. Description of the Related Art

Barbecue cooking activities generally provide outdoor cooking over an open flame on a grill. Such barbecue cooking is often performed during the day at picnics, in the evening, or the like. Due to the use of open flame, including charcoal briquettes and the burning of propane, such activity is relegated to the out of doors where there is sufficient ventilation and the risk of fumes or smoke is minimized in the well-ventilated outdoors.

While cooking during the day provides ample light by which barbecue grilling can occur, use of the barbecue in the late afternoon and early evening often imposes on the barbecue chef the risk of cooking in the dark. Once the sun goes down, there is generally little ambient light by which to monitor the barbecue grill and the items cooking upon it.

Previous attempts in the art have not addressed this problem well as few, if any, illuminating lights have been integrated into barbecue grills. Consequently, it would be an advance in the art to provide a barbecue having an illuminating light that was integrated into the barbecue for storage and could be advantageously used when needed to provide sufficient light to monitor the cooking activities on the barbecue.

### SUMMARY OF THE INVENTION

The present invention provides an illuminating lamp for a barbecue grill that is integrated into a shelf (folding or otherwise) that accompanies the barbecue and provides a flat surface upon which plates or other items may be temporarily placed during the barbecue cooking process.

The illuminating light extends upwardly and adjacent the cooking area to shine sufficient light to monitor the grilling activities and the barbecue, while not interfering with the upward convection flow of smoke and heat accompanying the barbecue while in use. This prevents the illuminating light from becoming occluded by smoke and other fumes, while also enabling it to stay out of the chef's way while providing light and illumination by which the chef can cook the food items or otherwise tend to the barbecue. The illuminating light may be battery-operated with the battery being under the shelf to protect the same from the ambient elements.

A shelf may or may not fold into the heat-producing area of the barbecue. Conformingly traveling along an inner or outer perimeter of the folding shelf, the illuminating light of the present invention is coupled to the shelf by a coupling or the like and may be powered by electricity in the form of a battery or fuel cell, as well as a fuel-based energization system, the same being positioned under the shelf to protect the same from the ambient, climatic elements. The lamp may be coupled to the shelf and when the shelf is hinged it may be positioned near the hinge with the barbecue and turns on when positioned to illuminate the grill area.

When stored or stowed, the intervening portion between the lamp and the shelf conforms neatly to the physical perimeter of the shelf. This stows the lamp away in a convenient manner, yet making it always ready for use.

A second complementing shelf-like member may also be attached to the barbecue and may provide recesses in which cooking utensils or other tools may be held to provide a generally second flat surface in aid and support of the chef's activities.

### OBJECTS OF THE INVENTION

It is an object of the present invention to provide illumination for a barbecue.

It is another object of the present invention to provide a safer barbecue environment when ordinary, ambient light may be absent.

It is another object of the present invention to provide an illuminating lamp for a barbecue that is easily and neatly stowed with the battery powering the lamp positioned to be protected from the ambient, climatic elements.

It is yet another object of the present invention to provide an illuminating lamp for a barbecue that is turned on in a convenient manner and only when needed.

These and other objects and advantages of the present invention will be apparent from a review of the following specification and accompanying drawings.

### BRIEF DESCRIPTION OF THE DRAWINGS

FIG. 1 is an elevational view of a barbecue system including the illuminating lamp and shelf members according to the present invention.

FIG. 2 is an exploded view of the barbecue shown in FIG. 1 with the illuminating lamp shown in a stowed position.

FIG. 3 is a front perspective view of a barbecue incorporating the lamp system of the present invention.

FIG. 4 is a front perspective view of the barbecue shown in FIG. 3 with the shelves folded inwardly.

FIG. 5 is a top left perspective view of the illuminating lamp shelf member and illuminating lamp shown in FIGS. 1-3.

FIG. 6 is a lower right perspective view of the illuminating lamp shelf member shown in FIG. 5.

FIG. 7 is a top left perspective view of an alternative embodiment of FIG. 5, with the illuminating lamp member sheltered by an exterior circumference ridge or step.

FIG. 8 is a lower right perspective view of the alternative embodiment of FIG. 7.

FIG. 9 is a top left perspective view of an alternative embodiment of FIG. 5 with respect to a square embodiment.

FIG. 10 is a lower right perspective view of the alternative embodiment of FIG. 9.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

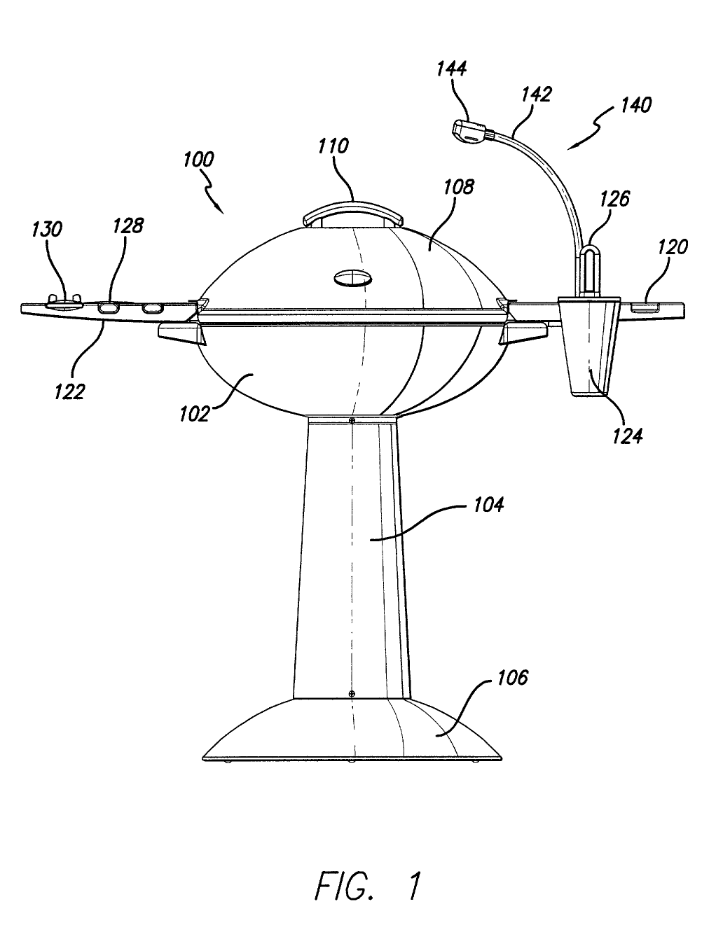

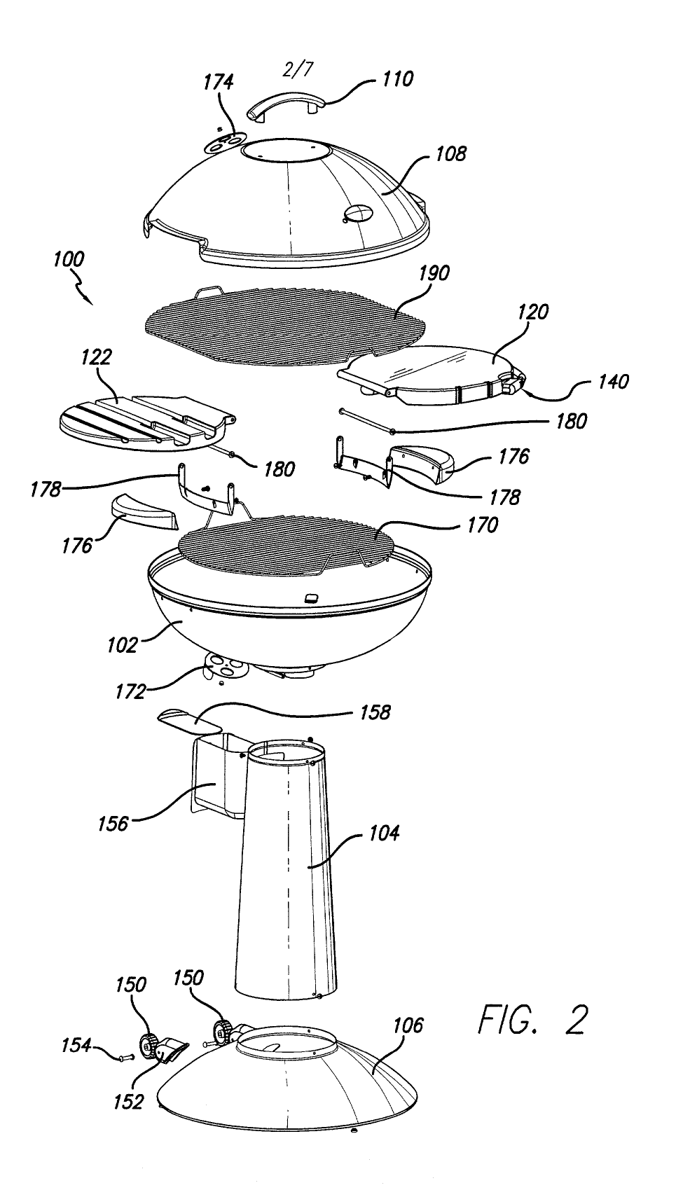

As shown in FIGS. 1 and 2, the barbecue 100 has a main fire pit bowl or burner 102 in which the coals for heat-producing activity is contained. The main fire bowl 102 is supported by a pedestal support 104 attached to a flared base 106.

The fire bowl 102 may be enclosed by a cover 108 that generally fits the fire bowl 102 in a sealing manner. A handle 110 centrally located atop the cover may be centrally attached to the cover 108. The handle 110 may be sufficiently insulated so that it may lift the cover, or lid, 108 away from the fire bowl 102 as well as placing it back again without burning a person's hands.

Also shown in FIG. 1 are a right shelf 120 and a left shelf 122. As described in more detail below, the right shelf has a sauce cup 124 in which a sauce brush 126 may be held. The left shelf 122 provides recesses 128 in which utensils such as tongs 130 may be held flush with the surface of the left shelf 122. As shown in FIG. 1, the right shelf 120 may have an illuminating lamp 140 extending upwardly from the shelf 120. A neck or stand 142 extends a lamp-holding portion 144 up and away from the shelf 120 in order to provide illumination to the grill.

In FIG. 2, an exploded view of the present invention is shown with the lamp 140 shown in the stowed or stored position, circumferentially engaging the right shelf 120.

The base 106 may have wheels 150 protected by wheel covers 152. The wheels may be attached to the wheel covers by means of an axle 154 with the wheel cover attached to the base 106. The pedestal support 104 is attached to the flared base 106 and may support or contain an ash catch 156. The ash catch may catch ashes falling in from the fire bowl 102. The ash catch 156 may be kept closed by a lock plate 158 or the like.

The fire bowl may internally support a charcoal grill 170 for supporting charcoal above the bottom of the fire bowl 102. This allows room for ash falling from the charcoal supported by the charcoal grill 170. Additionally, in conjunction with the lower vent 172 and the upper vent 174, the charcoal grill allows the burning charcoal to experience a draft with the flowing air better distributed throughout the confines of the barbecue 100. Handles 176 serve to provide means by which the barbecue 100 may be manually engaged about its circumference. The shelves 120, 122 may be attached to the fire bowl 102 by means of shelf brackets 178 through which pass shelf axles 180.

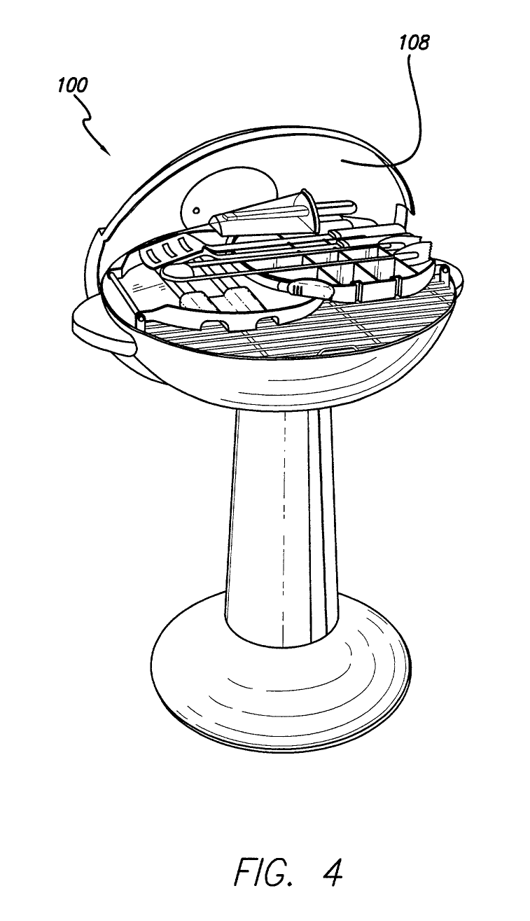

Shelf brackets 178 in combination with the shelf axles 180 may provide hinging means by which the shelves 120, 122 may fold into the barbecue as shown in FIG. 4 and be covered by the lid 108 as shown in FIG. 1. Alternatively, the shelves 120, 122 may be stationary and more rigidly connected or coupled to the fire bowl 102 or other structure of the barbecue 100. A cooking grill 190 provides a grilling surface upon which food may be cooked. The burning charcoal briquettes on the charcoal grill 170 heat the food present on the cooking grill 190 so as to cook the food thereon.

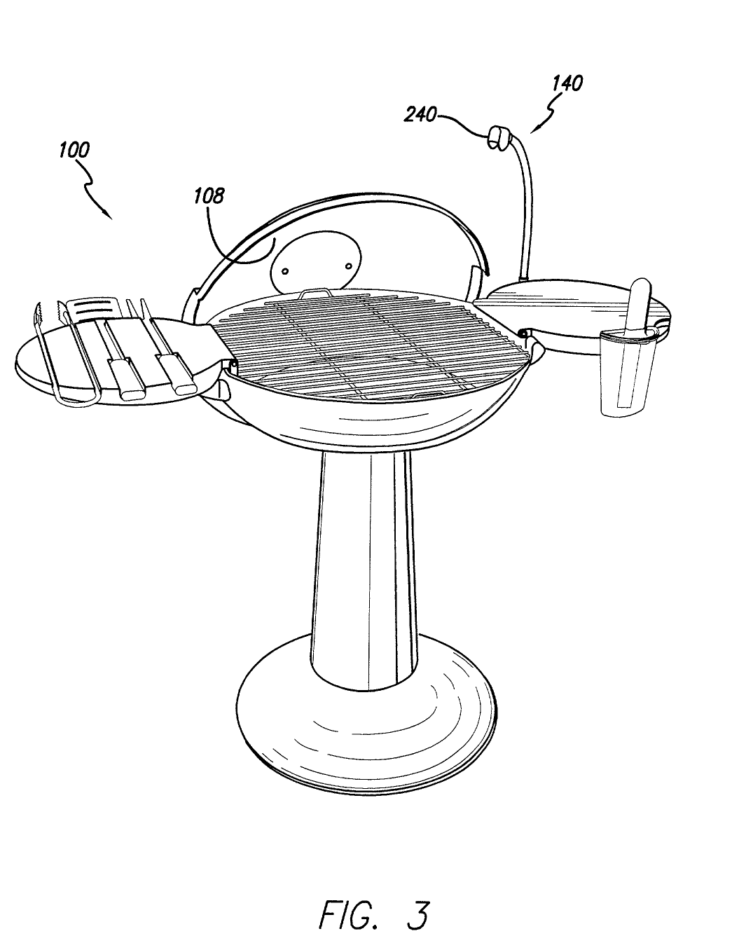

FIGS. 3 and 4 show respectively the unfolded and folded configurations of the present invention. It can be seen by visual inspection of FIGS. 3 and 4 that the present invention provides convenient means by which a number of utensils and useful items may be stowed and protected by the barbecue itself 100 under the cover 108. Of course, such stowage occurs when it can safely be done after any fire is completely extinguished and the barbecue has safely cooled down.

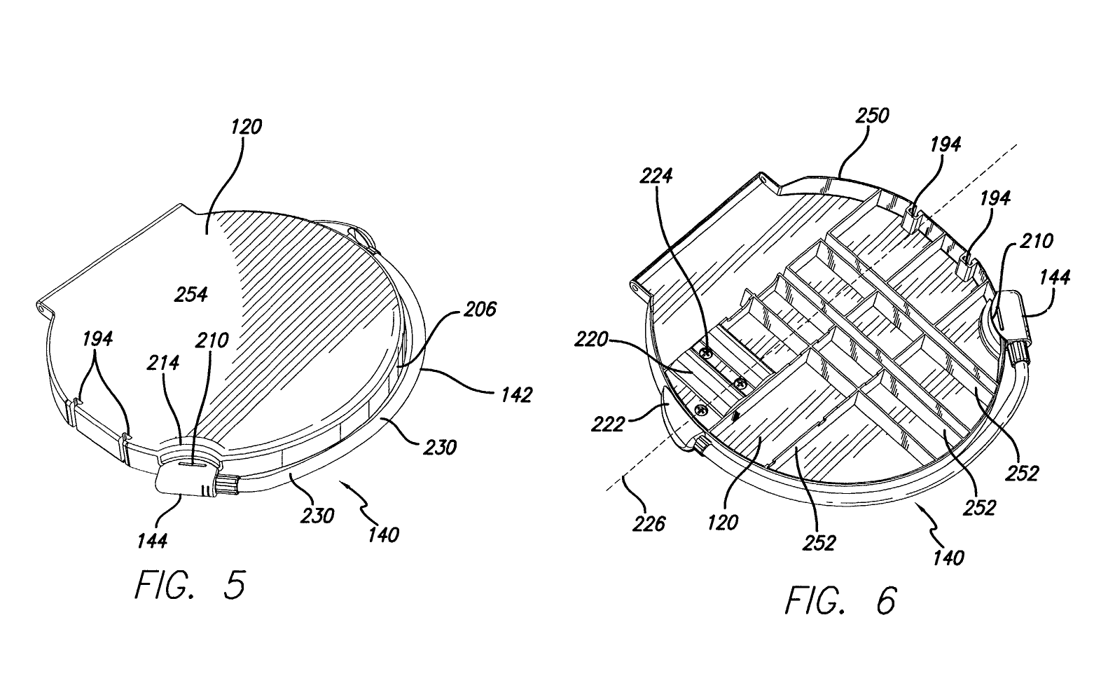

Of particular note in the present invention are those features shown in FIGS. 5 and 6. FIG. 5 is a top view of the right shelf 120, while FIG. 6 is a bottom view of the right shelf 120. In the present invention, the right and left shelves may generally be interchanged and the description given herein for the right shelf may be applicable for a similarly-disposed shelf based on the opposite side of the barbecue as, for example, would help a left-handed chef. Under such circumstances, the placement of the illuminating lamp 140 may need to be correspondingly changed from one side to the other. However, due to the modular nature of the present invention, certain efficiencies in manufacturing may lead to the easy placement of the illuminating lamp 140 on either side of the shelf 120.

As shown in FIGS. 5 and 6, the illuminating lamp 140 is generally stowed in a circumferential manner about the exterior of the shelf 120. The head of the lamp at the lamp holder 144 is generally within easy reach of the chef and may be adjacent to the slots 194 used to support and hold the sauce cup 124. The lamp holder 144 may have two outwardly curved and extending flanges 210 which in combination acts as a clip to secure the lamp holder 144 to the shelf 120. In order to effect such a clipping action, the outwardly-extending flanges 210 may clip upon a protrusion (not shown) present in an indentation 214 that allows the lamp holder 144 to generally conform to the exterior circumference 206 of the shelf 120.

As shown in FIG. 6, a battery case 220 may be provided in connection with the base of the lamp 222 in order to provide an energization system for the illuminating lamp 140. The battery case 220 may be held closed by screws 224 or the like, and the battery case 220 generally provides a weather-resistant seal in order to keep the batteries protected from the exterior elements such as rain and snow. As contemplated in the present invention, AA batteries are believed to be sufficient in order to power the light. However, other sizes of batteries, or other means of providing electrical power (such as fuel cells) may be advantageously implemented in the present invention. Additionally, a coupling 234 (FIG. 8) may be provided to allow the use of fuel, such as propane or white gas, to illuminate the lamp.

The base of the lamp 222 may provide an articulated connection between the shelf 120 and the illuminating lamp 140. When the lamp holder 144 is disengaged from the shelf 120 as by unclipping the outwardly extending flanges 210, the lamp stand 142 may then pivot upwardly about an imaginary axis through the lamp base 222 taken through the opposite side of the shelf 120. This articulation about this imaginary axis 226 allows the illuminating lamp to swing upright over the shelf 120 and preferably to be in a position in order to advantageously illuminate the grill as shown in FIG. 3. Certain segments 230 (FIG. 5) may be present along the lamp stand 142 in order to provide some means by which the lamp stand 142 may be adjusted and thereby provide adjustment to the lamp holder 144 and its lamp 240.

By restricting the articulated nature of the lamp stand 142, the lamp 140 is very easy to use and to position between the stored position and the active, illuminating position. When the lamp stand 142 is articulated with respect to the base 222, a contact switch or the like present inside the base 222 may serve to complete the circuit connection between the batteries present in the battery case 220 and the lamp 240 in the lamp holder 144. This causes the lamp to shine and to radiate light upon the grill 190. It also provides an easy way to switch on the lamp 240 and also protects the contact switch as it is present inside the articulating member system inside the lamp base 222. For fuel-based systems, it may also allow fuel flow and possibly activate a piezoelectric ignition system to light the lamp.

Alternative embodiments of the present invention are shown in the additional figures where the lamp stand is flexible in nature and provides more articulation with respect to its operation. Such configuration is commonly known as a “goose neck” and is known in the art.

Additionally, polygonal shapes for the shelf 120 may be achieved and usefully implemented in the present invention. In that case, articulating the flexible linkages may be used in order to conform the lamp stand 142 to the circumference of the polygonal shelf 120.

Furthermore, the stowage of the lamp 140 may be achieved by allowing it to conform to an interior circumference of the shelf 120 or a lower and protected circumference of the shelf 120. By providing a sufficiently articulating base that would allow the lamp to be stored within the lip 250, the illuminating lamp 140 would then be further protected by the shelf 120. Such ambient-element protection by the shelf 120 for the illuminating lamp 140 provides further advantage to and longer life for the illuminating lamp 140. While FIG. 6 shows a number of supporting ribs 252 that provide support for the upper surface 254 of the shelf, accommodation may be made in the present invention to allow the illuminating lamp 140 to articulate beneath and travel within the further protection of the shelf lip 250. This is both true for the curvilinear embodiment shown in FIGS. 5 and 6, as well as the polygonal figures shown in the remaining drawings.

As used herein, the term “polygon” and its derivatives are meant to intend figures having any number of sides including those having one side such as circles. Such a definition of polygon is known in the art with respect to shapes defined by world lines on the surface of a sphere. A single world line of a sphere would define a circle and would meet the definition of polygon as set forth herein.

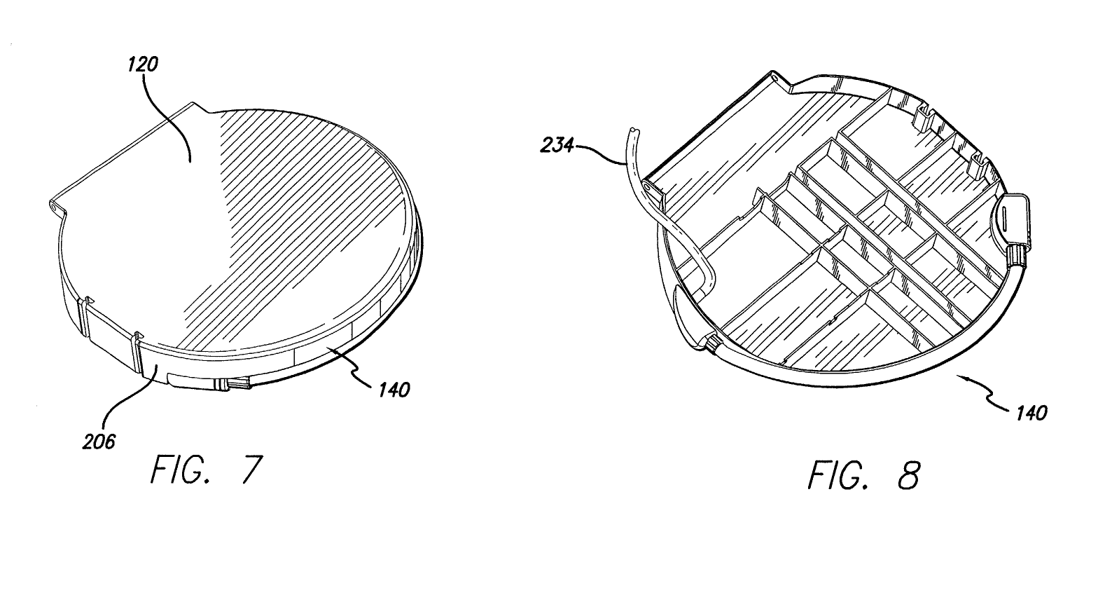

As shown in FIGS. 7-10, similar elements are marked with similar reference numbers. However, FIGS. 7 and 8 show an alternative embodiment of the shelf 120 shown in FIGS. 5 and 6, as the illuminating lamp 140 is tucked below and sheltered by the exterior circumference 206 of the shelf 120. A ridge or step (not shown) can provide such operability for the embodiments shown in FIGS. 7 and 8, which otherwise is constructed in a manner similar to that of the embodiments shown in FIGS. 5 and 6.

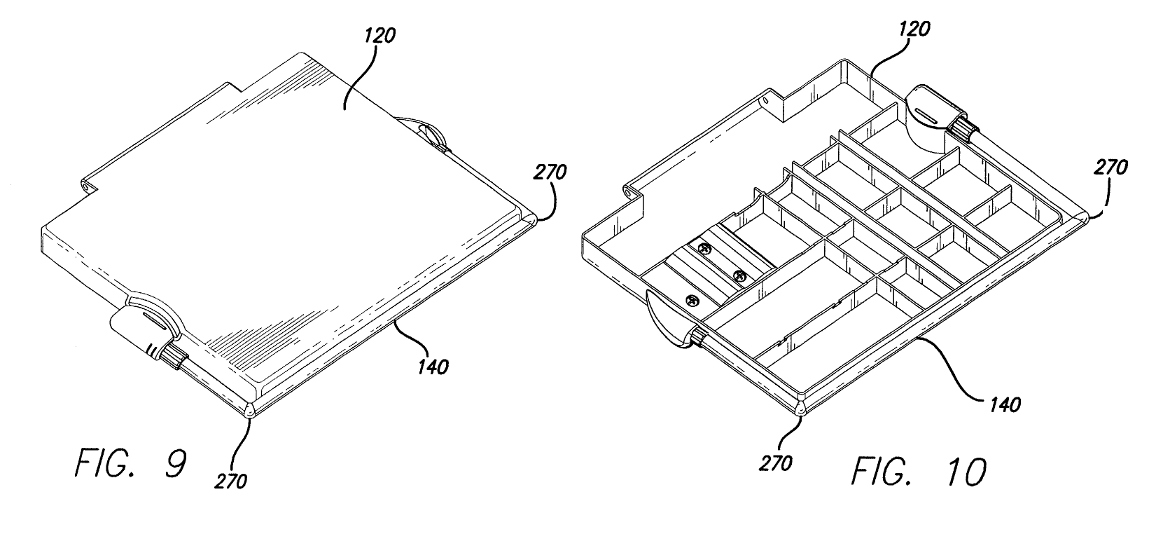

FIGS. 9 and 10 show an alternative embodiment of the shelf 120 with respect to a square embodiment. In this case, the illuminating lamp 140 is angular in nature and is connected as by linkages 270 in order to give greater flexibility and operability.

As can be seen by the exemplary and alternative embodiments, the shelf 120 of the present invention can take several configurations and the geometry of the associated illuminating lamp 140 can also be configured in a number of ways with respect to the shelf 120.

As indicated above, the illuminating lamp 140 can be effected in one or more configurations that set the illuminating lamp 140 entirely within the underside or interior of the shelf 120 to provide even additional protection than the embodiments shown in FIGS. 7 and 8.

While the present invention has been described with regards to particular embodiments, it is recognized that additional variations of the present invention may be devised without departing from the inventive concept.

What is claimed is:

1. A barbecue device comprising the combination of:
a heat-producing member having a first, laterally-extending shelf-forming member adapted to be about positioned adjacent relative to said heat-producing member; said first, laterally-extending shelf-forming member having a polygonal configuration and having associated therewith a lighting device adapted to about conform to the configuration of said first, laterally-extending shelf member, an energy source for said lighting device being positioned in ambient-element-protected location relative to said shelf-forming member.

2. The barbecue device as set forth in claim 1, further comprising:
said shelf being hingedly coupled to said heat-producing member and adapted to be positioned though one-hundred-eighty degrees (180°) relative to said heat-producing member.

3. The barbecue device as set forth in claim 1, further comprising:
said polygonal configuration being curvilinear.

4. The barbecue device as set forth in claim 3, further comprising:
said curvilinear configuration being circular.

5. The barbecue device as set forth in claim 1, further comprising:
said first, laterally-extending hinged shelf-forming member adapted to be positioned through one hundred eighty degrees (180°) relative to said heat-producing member; and
a flexible extension conformable to a circumference of said first, laterally-extending shelf member, said lighting device coupled to said first, laterally-extending shelf member by said flexible extension.

6. The barbecue device as set forth in claim 1, further comprising:
a cover covering said heat-producing member; and
said first, laterally-extending shelf member foldable within said heat-producing member, said cover also protecting said first, laterally-extending shelf member.

7. The barbecue device as set forth in claim 6, further comprising:
said cover congruent in shape to said heat-producing member so as to provide a proper fit between said cover and said heat-producing member.

8. The barbecue device as set forth in claim 1, further comprising:
an energizing system for said lighting device, said energizing system supplying energy to said lighting device and enabling said lighting device to emit light.

9. The barbecue device as set forth in claim 8, wherein said energizing system comprises:
a battery for supplying electrical power coupled to said lighting device, said battery located on an underside of said first, laterally-extending shelf member so as to be protected by said first, laterally-extending shelf member.

10. The barbecue device as set forth in claim 9, wherein said energizing system comprises:
a fuel supply coupled to said lighting device and supplying fuel to said lighting device.

11. The barbecue device as set forth in claim 10, further comprising:
said fuel supply supplying fuel from the group consisting of propane and white gas.

12. The barbecue device as set forth in claim 5, further comprising:
a linkage member coupling to said flexible extension to said energizing system, said linkage member providing a base for said flexible extension adjacent said first, laterally-extending hinged shelf-forming member.

13. The barbecue device as set forth in claim 1, further comprising:
a second laterally-extending hinged shelf-forming member adapted to be about superpositioned relative to said heat-producing member; said second, laterally-extending hinged shelf-forming member defining utensil recesses for receiving barbecue utensils, said utensil recesses defined so that upon receiving barbecue utensils, tops of said barbecue utensils are flush with a surface of said second laterally-extending hinged shelf-forming member.

14. A barbecue device comprising the combination of:
a heat-producing member having a first, laterally-extending shelf-forming member adapted to be about positioned relative to said heat-producing member;
said first, laterally-extending shelf-forming member having a polygonal configuration and having associated therewith a lighting device adapted to about conform to the configuration of said first, laterally-extending shelf member;
a flexible extension conformable to a circumference of said first, laterally-extending shelf member, said lighting device coupled to said first, laterally-extending shelf member by said flexible extension;
a cover congruent in shape to said heat-producing member so as to provide a proper fit between said cover and said heat-producing member, said cover covering said heat-producing member;
an energizing system for said lighting device, said energizing system supplying energy to said lighting device and enabling said lighting device to emit light, said energizing system being positioned in ambient-element-protected location relative to said shelf-forming member; and
a linkage member coupling to said flexible extension to said energizing system, said linkage member providing a base for said flexible extension adjacent said first, laterally-extending shelf-forming member.

15. The barbecue device as set forth in claim 14, further comprising:
said shelf being hingedly coupled to said heat-producing member and adapted to be positioned though one-hundred-eighty degrees (180°) relative to said heat-producing member; and
said first, laterally-extending shelf member foldable within said heat-producing member, said cover also protecting said first, laterally-extending shelf member.

16. A barbecue device as set forth in claim 14, further comprising:
said polygonal configuration being curvilinear.

17. A barbecue device as set forth in claim 14, further comprising:
said curvilinear configuration being circular.

18. A barbecue device as set forth in claim 14, wherein said energizing system comprises:
a battery for supplying electrical power coupled to said lighting device, said battery located on an underside of said first, laterally-extending shelf member so as to be protected by said first, laterally-extending shelf member.

19. A barbecue device as set forth in claim 14, wherein said energizing system comprises:
a fuel supply coupled to said lighting device and supplying fuel to said lighting device;
said fuel supply supplying fuel from the group consisting of propane and white gas.

20. A barbecue device as set forth in claim 14, further comprising:
a second laterally-extending hinged shelf-forming member adapted to be about superpositioned relative to said heat-producing member; said second, laterally-extending hinged shelf-forming member defining utensil recesses for receiving barbecue utensils, said utensil recesses defined so that upon receiving barbecue utensils, tops of said barbecue utensils are flush with a surface of said second laterally-extending hinged shelf-forming member.
